(19) United States
(12) Patent Application Publication
(10) Pub. No.: US 2025/0224377 A1
(43) Pub. Date: Jul. 10, 2025

(54) DETECTION DEVICE AND METHOD OF DRIVING THE SAME

(71) Applicant: TAIYO YUDEN CO., LTD., Tokyo (JP)

(72) Inventor: Hiroya HOJYO, Tokyo (JP)

(21) Appl. No.: 19/092,291

(22) Filed: Mar. 27, 2025

Related U.S. Application Data
(63) Continuation of application No. PCT/JP2023/024436, filed on Jun. 30, 2023.

(30) Foreign Application Priority Data
Sep. 30, 2022 (JP) 2022-158942

(51) Int. Cl. G01N 29/02; G01N 29/22

(52) U.S. Cl. CPC G01N 29/022; G01N 29/222; G01N 2291/0255; G01N 2291/0256; G01N 2291/0423

(57) ABSTRACT

A detection device includes a storage member in which liquid is stored, a sensor chip that is provided on the storage member and has a sensitive membrane on a lower surface thereof, and a pressing member that is provided below the sensitive membrane, and presses the storage member to supply the liquid to the sensitive membrane when the sensor chip is pressed downward.

### CROSS-REFERENCE TO RELATED APPLICATION

This application is a continuation application of PCT/JP2023/024436 filed on Jun. 30, 2023, which claims priority to Japanese Patent Application No. 2022-158942 filed on Sep. 30, 2022, the entire contents of which are incorporated herein by reference.

### FIELD

A certain aspect of the present disclosure relates to a detection device and a method of driving the same.

### BACKGROUND

As a method of supplying a liquid such as a sample liquid to a sensor in order to detect substances or the like in the liquid, a method using a flow path is known as disclosed in, for example, U.S. Patent Publication No. 2013/0156644 (Patent Document 1). A method of supplying a liquid to a sensitive membrane by using capillary action is known as disclosed in, for example, Japanese Patent Application Laid-Open Nos. 2013-152209, 2013-96866, and 2021-47051 (Patent Documents 2 to 4).

### SUMMARY

When a flow path is used to supply a liquid to the sensitive membrane, a pump is used to pump the liquid, which increases the size of the detection device. When capillary action is used to supply a liquid to the sensitive membrane, a pump is not used, which allows for miniaturization. However, when capillary action is used, the rate at which the liquid is supplied to the sensitive membrane is low.

In one aspect of the present disclosure, there is provided a detection device including a storage member in which liquid is stored, a sensor chip that is provided on the storage member and has a sensitive membrane on a lower surface thereof, and a pressing member that is provided below the sensitive membrane, and presses the storage member to supply the liquid to the sensitive membrane when the sensor chip is pressed downward.

In another aspect of the present disclosure, there is provided a method of driving a detection device, the method including: preparing: a sensor chip having a sensitive membrane on a lower surface thereof, a sensor substrate having a lower surface on which the sensor chip is provided, a first electrode electrically connected to the sensor chip being provided around the sensor chip, and a support substrate that has a recess or an opening portion in which the sensor chip is accommodated, and has a second electrode on an upper surface of the support substrate at a position opposite the first electrode of the sensor substrate; and inserting the sensor chip into the recess or the opening portion of the support substrate, and electrically connecting the first electrode and the second electrode by a force applied to the sensor substrate toward the support substrate.

### BRIEF DESCRIPTION OF THE DRAWINGS

FIG. 1A to FIG. 1D are cross-sectional views of a detection device in accordance with a first embodiment;

FIG. 2 is an exploded perspective view of a detection device in accordance with a second embodiment;

FIG. 3 is an exploded perspective view of a sensor substrate, a sensor chip, and a pressing member in the second embodiment;

FIG. 4 is a top view of a support substrate and a tray in the second embodiment;

FIG. 5A and FIG. 5B are a bottom view and a top view of the sensor substrate in the second embodiment, respectively;

FIG. 6 is a bottom view of the sensor chip in the second embodiment;

FIG. 7 is a cross-sectional view taken along line A-A in FIG. 6;

FIG. 8 is a cross-sectional view taken along line A-A in FIG. 4 to FIG. 5B;

FIG. 9 is a plan view of the tray, a storage member, and the sensor chip in the second embodiment;

FIG. 10 is a block diagram of the detection device in the second embodiment;

FIG. 11 is a cross-sectional view for describing a method of supplying a liquid to a sensitive membrane in the second embodiment;

FIG. 12 is a cross-sectional view for describing the method of supplying the liquid to the sensitive membrane in the second embodiment;

FIG. 13 is a cross-sectional view of a detection device in accordance with a first variation of the second embodiment;

FIG. 14 is a cross-sectional view of a detection device in accordance with a second variation of the second embodiment;

FIG. 15 is a plan view of the tray, the storage member, and the sensor chip in the second variation of the second embodiment;

FIG. 16 is a cross-sectional view of a detection device in accordance with a third embodiment;

FIG. 17 is a plan view of the pressing member, the tray, the storage member, and the sensor chip in the third embodiment;

FIG. 18 is a cross-sectional view for describing a method of supplying the liquid to the sensitive membrane in the third embodiment; and

FIG. 19 is a cross-sectional view for describing the method of supplying the liquid to the sensitive membrane in the third embodiment.

### DETAILED DESCRIPTION

Hereinafter, embodiments will be described with reference to the drawings.

### First Embodiment

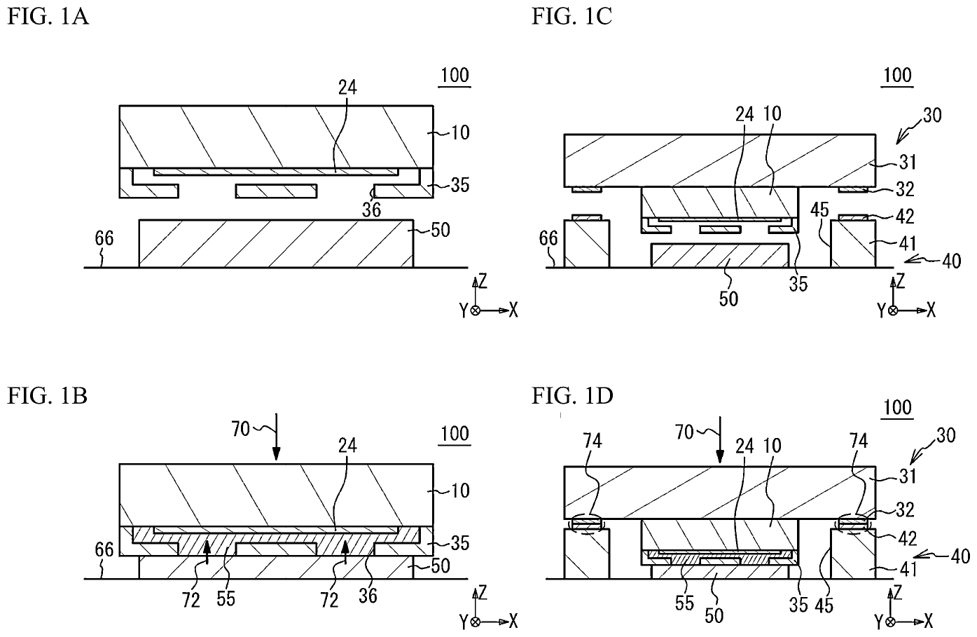

FIG. 1A to FIG. 1D are cross-sectional views of a detection device in accordance with a first embodiment. A vertically upward direction (a direction opposite to the direction of gravity) is defined as a Z direction, and directions that are orthogonal to the Z direction and directions in which the sides of a sensor chip having a rectangular planar shape extend are defined as an X direction and a Y direction.

As illustrated in FIG. 1A, in a detection device 100, a storage member 50 is provided on a base 66 such as a tray. The storage member 50 stores a liquid 55 and has flexibility. The liquid contains a substance to be detected by the detection device 100. Hereinafter, this liquid is also referred to as a sample liquid. A sensor chip 10 is placed above the storage member 50. A sensitive membrane 24 is provided on the lower surface of the sensor chip 10. The sensitive membrane 24 is a membrane on which a specific substance in the liquid is adsorbed. A pressing member 35 fixed to the sensor chip 10 is provided below the sensitive membrane 24. The pressing member 35 has openings 36.

As illustrated in FIG. 1B, when a downward force indicated by an arrow 70 is applied to the sensor chip 10, the pressing member 35 presses the storage member 50. The storage member 50 is crushed by the pressing member 35, and thereby, the liquid 55 stored in the storage member 50 moves from the storage member 50 toward the sensitive membrane 24. The liquid 55 flows upward, as indicated by arrows 72, through the openings 36 and is fed into the space formed by the pressing member 35 and the surface with the sensitive membrane 24 of the sensor chip 10. This exposes the sensitive membrane 24 to the liquid 55.

As will be described in detail later, for example, the storage member 50 is a member that retains liquid, such as filter paper or sheet-shaped absorbent cotton. The pressing member 35 functions as a sensor cover. When the lower surface of the pressing member 35 reaches the storage member 50, the sensor surface of the sensor chip 10 on which the sensitive membrane 24 is provided and the inner surface of the pressing member 35 form a space that is sealed to some extent. A further downward force indicated by the arrow 70 causes some of the liquid 55 in the storage member 50 to enter this space. This is a water gun-like action.

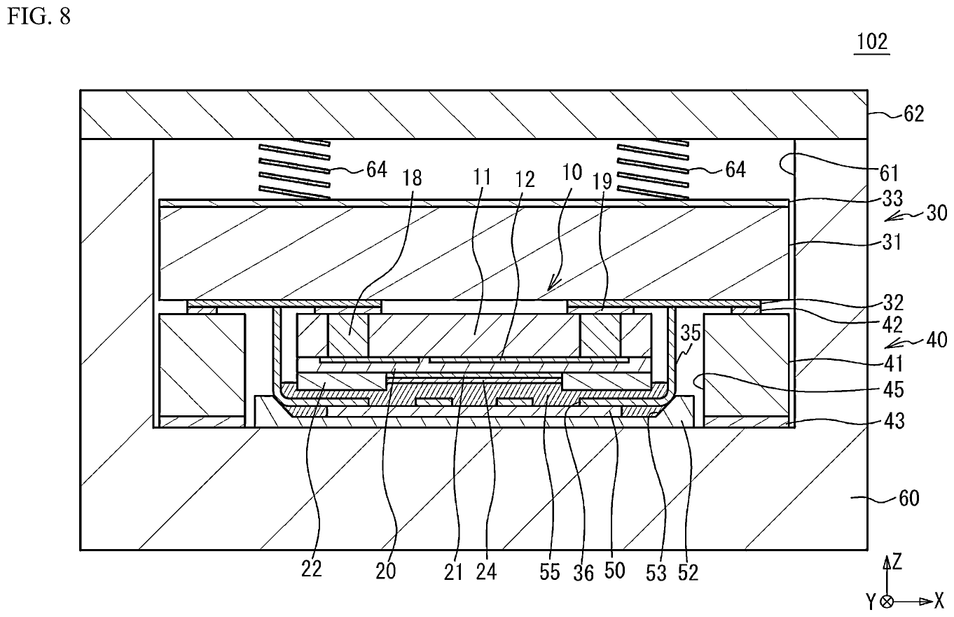

When the pressing member 35 is made of a flexible plastic or metal, the area of the surface of the pressing member 35 that comes into contact with the storage member 50 is increased, and the effect of pushing out the liquid 55 is enhanced. A part closer to the sensor surface of the pressing member 35 preferably has an air escape port. As the air escape port, a hole may be provided in a part of the sensor chip 10 or a part of the pressing member 35. For example, when a part of the portion facing the sensor chip 10 of the pressing member 35 does not comes in contact with the storage member 50 and is recessed, the liquid does not leak and the air can be easily released. The recess may be formed by shaving a part of the sensor chip 10. As described above, in the first embodiment, instead of a pump for supplying the liquid 55, an external force is applied downward, as indicated by the arrow 70. The external force corresponds to, for example, the force of the hand of the operator, the self-weight of the detection device 100, or the force of an elastic body 64 (see FIG. 8 described later) such as a spring.

The conventional techniques have the following problems. As a conventional method of supplying the liquid 55, there are a method using an electric component such as a pump and a method using capillary action. However, the former requires the incorporation of a pump, which makes the configuration complex and large. The latter has a problem of a low liquid feeding speed because of the use of capillary action.

In contrast, in the first embodiment, the pressing member 35 provided below the sensitive membrane 24 presses the storage member 50 and causes the liquid 55 to reach the sensitive membrane 24. For example, the storage member 50 absorbs the liquid 55 and sends the liquid 55 when pressed by the pressing member 35. This eliminates the need for a pump or the like, and thus the detection device 100 can be downsized. Further, the liquid 55 can be quickly supplied to the sensitive membrane 24 in response to the pressing.

The sensor chip 10 is connected to a detection circuit. For example, in FIG. 1A and FIG. 1B, the sensor chip 10 and the detection circuit that drives the sensor chip 10 are electrically connected before the pressing member 35 presses the storage member 50. Therefore, the sensor chip 10 is ready to detect the specific substance before the pressing member 35 presses the sensor chip 10. The state in which the sensor chip 10 is ready to detect the specific substance is, for example, a state in which a current flows between electrodes in the case that the sensor chip 10 is of a resistance type, a state in which a voltage is applied between electrodes in the case that the sensor chip 10 is of a capacitance type, and a state in which a voltage and mechanical vibration are applied to the sensor chip 10 in the case that the sensor chip 10 is of a vibration type.

In contrast to the case where the sensor chip 10 and the detection circuit are electrically connected to each other before the pressing member 35 presses the storage member 50, in FIG. 1C and FIG. 1D described below, the sensor chip 10 and the detection circuit are electrically connected to each other when the pressing member 35 presses the storage member 50. Therefore, the driving time during which the current flows through the sensor chip 10 or the voltage is applied to the sensor chip 10 can be greatly reduced. This can reduce power consumption. Further, it is possible to suppress deterioration of the sensor chip 10 due to a long driving time of the sensor chip 10.

As illustrated in FIG. 1C, in the detection device 100 of the first embodiment, the sensor chip 10 is mounted on the lower surface of a sensor substrate 30. The sensor substrate 30 includes electrodes 32 (first electrode) provided on the lower surface of a substrate 31. The electrode 32 is electrically connected to the sensor in the sensor chip 10. The electrodes 32 are provided on the lower surface of the substrate 31 so as to surround the sensor chip 10. In FIG. 1C, two electrodes 32 are provided at the left and right sides of the sensor chip 10, respectively. The electrode 32 may be an electrode having a rectangular planar shape, and the number of the electrodes 32 may be just one.

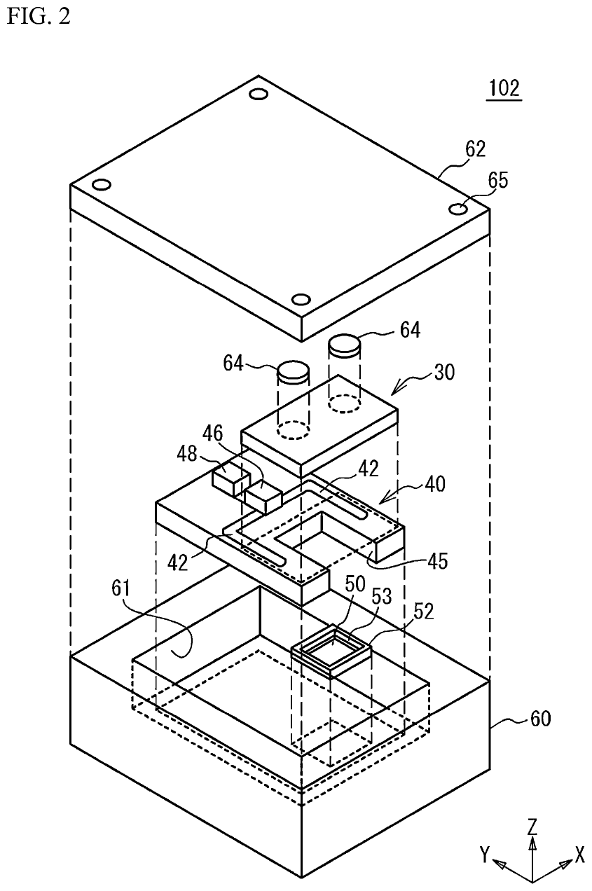

Electrodes 42 (second electrode) are provided on the upper surface of a substrate 41 of a support substrate 40 at positions opposite the electrodes 32, and an opening (recess 45) slightly larger than the sensor chip 10 is provided further in than the electrodes 42. The substrate 41 has a detection circuit for driving the sensor chip 10, and the substrate 41 is fixed in a housing chamber 61 (see FIG. 2 described later). In FIG. 2 described later, the opening is described as the recess 45 (recess portion), and one side (lower right side in FIG. 2) of the rectangle in a plan view is opened in the recess 45. This makes it easier to insert the sensor chip 10 into the recess 45 through the opening. In this case, the electrodes 42 are C-shaped as a whole. In this manner, the sensor chip 10, the sensor substrate 30, and the support substrate 40 are prepared.

FIG. 1D illustrates a contact structure. The sensor chip 10 can be inserted into the recess 45, and thus the electrodes 32 and the electrodes 42 can be brought into contact with each other by a downward force indicated by the direction of the arrow 70, for example, the self-weight of the sensor substrate 30 or the sensor chip 10, or by an operator's manual pressing. The electrodes 42 are electrically connected to a detection circuit or the like. As illustrated in FIG. 8 described later, the upper surface of the support substrate 40 may have the recess 45. The storage member 50 is provided in the recess 45. When the sensor chip 10 is placed above the storage member 50, the electrodes 32 and 42 are placed so as to face each other.

As illustrated in FIG. 1D, when the sensor substrate 30 is pressed downward toward the support substrate 40 as indicated by the arrow 70, the electrodes 32 come into contact with the electrodes 42 in respective regions 74, and the sensor chip 10 and the detection circuit are electrically connected. In this manner, by pressing the sensor substrate 30, the electrodes 32 can be brought into contact with the electrodes 42, and the liquid 55 can be supplied to the sensitive membrane 24.

In the method of driving the detection device 100 illustrated in FIG. 1C and FIG. 1D, when the sensor substrate 30 is pressed downward by a downward external force (or its own weight) as indicated by the arrow 70, the liquid is fed to the sensitive membrane 24 of the sensor chip 10. Therefore, a pump is not required, and the structure can be simplified and miniaturized. At the same time, the sensor chip 10 is electrically connected to the detection circuit by the pressing, and detects the substance in the liquid. In this manner, the sensor chip 10 is driven by being pressed. Therefore, the deterioration of the sensor chip 10 can be suppressed, and the power consumption can be reduced. In FIG. 1C and FIG. 1D, the substrate 41 is provided in contact with the base 66 on which the storage member 50 is provided. However, the substrate 41 may be provided on the bottom surface of the housing chamber 61 of a housing body 60 as illustrated in FIG. 2 described later.

In the following embodiments, the detection device will be described in more detail.

### Second Embodiment

FIG. 2 is an exploded perspective view of a detection device in accordance with a second embodiment. A vertically upward direction is defined as a Z direction, a long side direction of a planar shape of the sensor substrate 30 is defined as an X direction, and a short side direction is defined as a Y direction.

As illustrated in FIG. 2, in a detection device 102, the housing body 60 is, for example, a rectangular parallelepiped. The housing chamber 61 for housing the sensor substrate 30, the support substrate 40, and a tray 52 is provided on the upper surface of the housing body 60. The planar shape of the housing chamber 61 is, for example, rectangular. The support substrate 40 is fixed to the bottom surface of the housing chamber 61. The electrodes 42, a detection circuit 46, and a power circuit 48 are provided on the upper surface of the support substrate 40. The tray 52 is disposed on the bottom surface of the housing chamber 61 and in the recess 45 of the support substrate 40. The storage member 50 is provided in a recess portion 53 on the upper surface of the tray 52. The sensor substrate 30 is disposed on the support substrate 40 and over the recess 45. The elastic bodies 64 such as springs are provided on the sensor substrate 30. The housing chamber 61 of the housing body 60 is covered with a lid member 62. The lid member 62 has screw holes 65. The lid member 62 is fixed to the housing body 60 by screwing. By removing the screws, the lid member 62 is removed, and the sensor substrate 30 can be easily replaced. Therefore, the pressing member 35 covering the sensor chip 10 attached to the rear surface of the sensor substrate 30 presses the storage member 50 and sends the liquid 55 to the sensitive membrane 24 of the sensor chip 10 as illustrated in FIG. 1D.

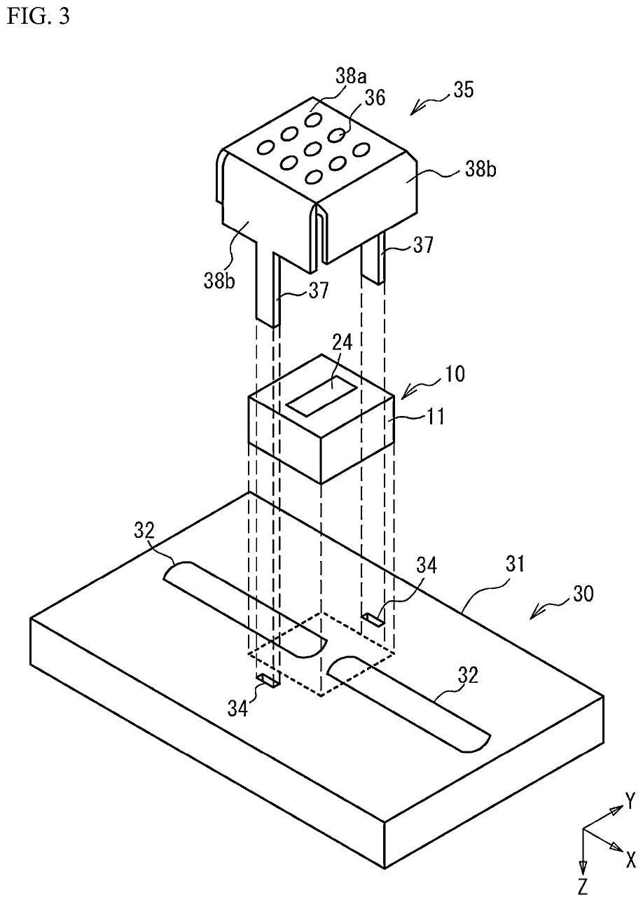

FIG. 3 is an exploded perspective view of the sensor substrate, the sensor chip, and the pressing member in the second embodiment.

As illustrated in FIG. 3, the electrodes 32 are provided on the lower surface (upper surface in FIG. 3) of the substrate 31 of the sensor substrate 30. Through-holes 34 penetrating through the substrate 31 are provided. The sensor chip 10 is mounted on the lower surface of the sensor substrate 30. The sensitive membrane 24 is provided on the lower surface of the sensor chip 10. The pressing member 35 is a member formed by bending a metal plate, for example. The pressing member 35 has a lower plate 38a and side plates 38b. The planar shape of the lower plate 38a is, for example, rectangular, and four side plates 38b are bent in the +Z direction from four sides of the rectangle, respectively. Arms 37 (insertion plates) extend in the +Z direction from the +Z ends of a pair of the side plates 38b facing each other. The arms 37 are inserted into the through-holes 34 of the sensor substrate 30, respectively. The arm 37 is bent along the upper surface of the sensor substrate 30 and is bonded to the sensor substrate 30 by, for example, soldering. The pressing member 35 may be formed by drawing a metal. Further, the pressing member 35 may be formed at a time by injection molding using a metal mold. At least the surface of the pressing member 35 is preferably an insulator to prevent electric short-circuiting between the pressing member 35 and a metal film 21 and between the pressing member 35 and a surface acoustic wave resonator 25 via the liquid 55.

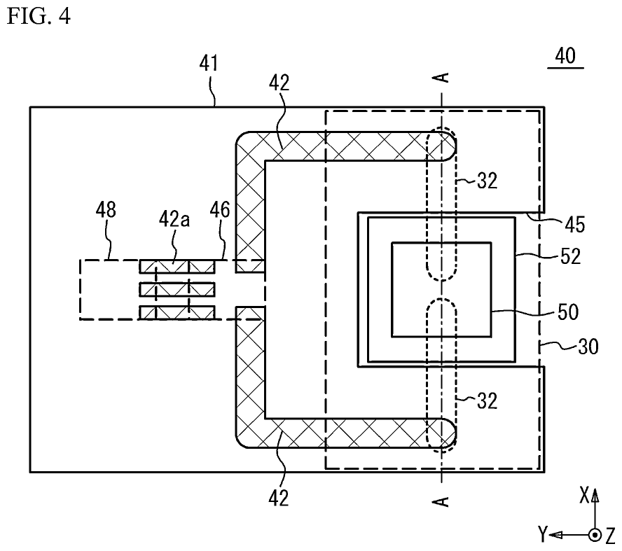

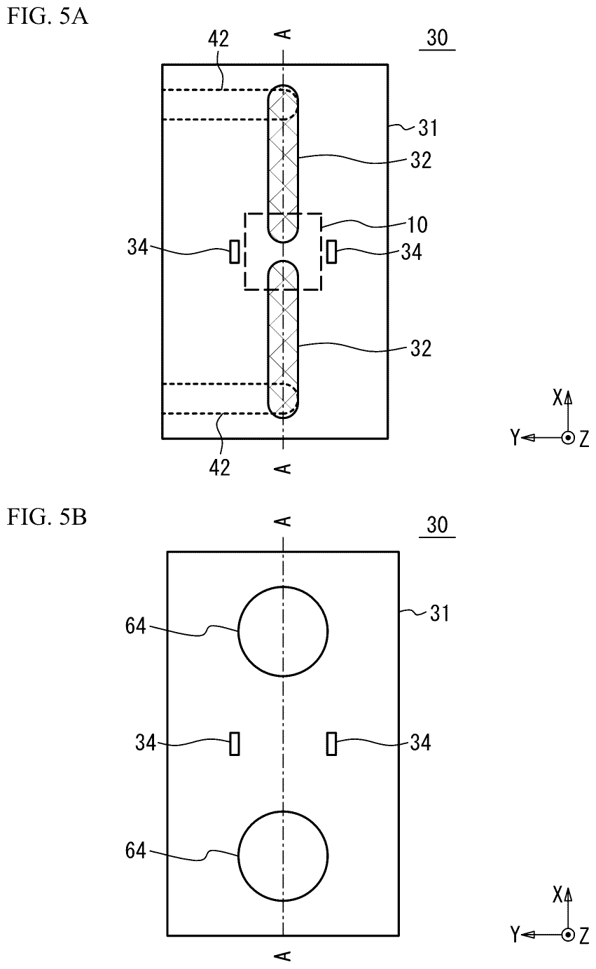

FIG. 4 is a top view of the support substrate and the tray in the second embodiment. FIG. 5A and FIG. 5B are a bottom view and a top view of the sensor substrate in the second embodiment, respectively. In FIG. 4, the sensor substrate 30, the electrodes 32, the detection circuit 46, and the power circuit 48 are indicated by broken lines. FIG. 5A is a perspective view of the lower surface of the sensor substrate 30 as viewed from above. The sensor chip 10 and the electrodes 42 are indicated by broken lines.

As illustrated in FIG. 4, the support substrate 40 has the recess 45. The recess 45 penetrates through the support substrate 40 in the Z direction. The recess 45 may not necessarily penetrate through the support substrate 40. The tray 52 provided with the storage member 50 is disposed in the recess 45. The detection circuit 46 and the power circuit 48 are provided on the support substrate 40 on the opposite side (+Y direction) from the open portion (−Y direction portion) of the recess 45. Electrodes 42 and 42a are provided on the upper surface of the substrate 41. The longitudinally extending portion of the C-shape of the electrode 42 is connected to the detection circuit 46. A pair of laterally extending portions of the C-shape of the electrodes 42 are provided at both sides of the recess 45 toward the opening portion, along the upper and lower sides of the recess 45, respectively. The electrodes 42a electrically connect the detection circuit 46 and the power circuit 48.

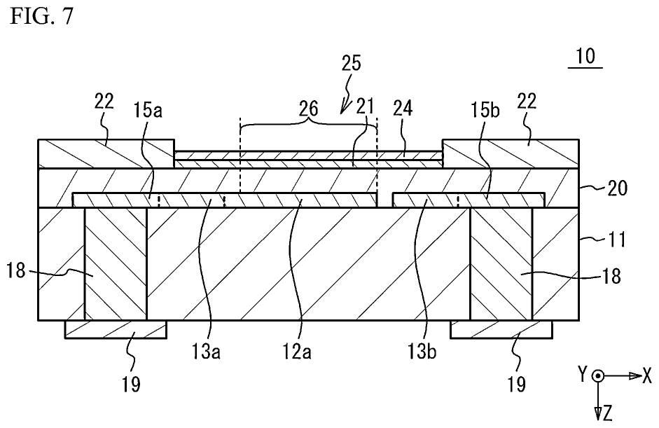

As illustrated in FIG. 5A, a pair of the electrodes 32 are provided on the lower surface of the sensor substrate 30. The opposing portions of the two electrodes 32 overlap the rear surface of the sensor chip 10 to be surface-mounted. The two electrodes 32 are mounted by soldering to terminals 19 (see FIG. 7) on the rear surface of the sensor chip 10.

FIG. 5B illustrates the elastic bodies 64 on the upper surface of the sensor substrate 30. As illustrated in FIG. 8, which will be described later, the elastic bodies 64 attached to the lid member 62 are in contact with the upper surface of the sensor substrate 30. The elastic body 64 may be attached to the sensor substrate 30.

As illustrated in FIG. 4 and FIG. 5A, when the sensor substrate 30 is placed on the support substrate 40, the sensor substrate 30 is placed so as to cover the recess 45, and a second end of the electrode 32 and a second end of the electrode 42 are placed so as to overlap each other.

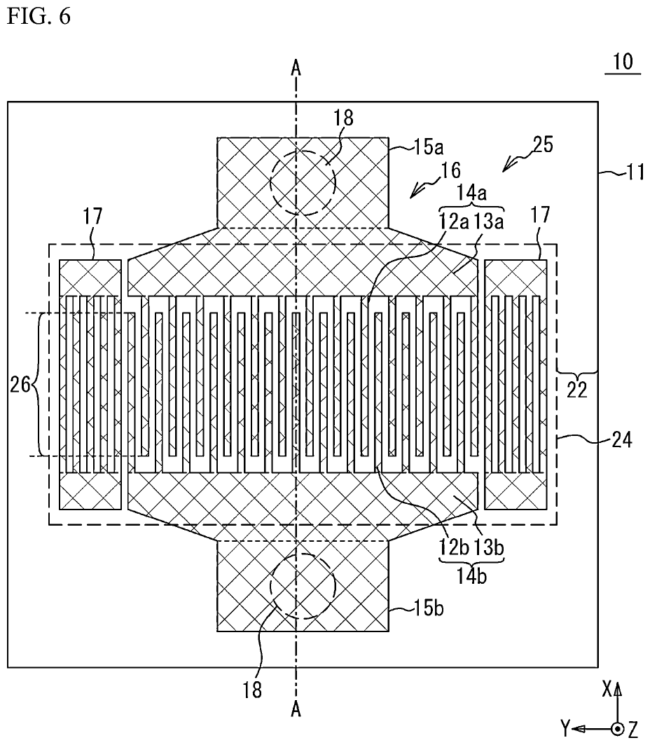

FIG. 6 is a bottom view of the sensor chip in the second embodiment, and FIG. 7 is a cross-sectional view taken along line A-A in FIG. 6. The direction in which electrode fingers 12a and 12b extend is the X direction (vertical direction), and the direction in which the electrode fingers 12a and 12b are arranged is the Y direction (horizontal direction). In FIG. 6, the sensitive membrane 24 provided on the electrode fingers 12a and 12b is indicated by a broken line.

As illustrated in FIG. 6 and FIG. 7, the surface acoustic wave resonator 25 is provided as a sensor on the lower surface of a substrate 11 of the sensor chip 10. The surface acoustic wave resonator 25 includes an interdigital transducer (IDT) 16 and reflectors 17. The IDT 16 and the reflectors 17 are formed of a metal film. The IDT 16 is interposed between a pair of the reflectors 17 in the Y direction.

The IDT 16 includes a pair of comb-shaped electrodes 14a and 14b. The comb-shaped electrode 14a includes a plurality of the electrode fingers 12a and a bus bar 13a, and the comb-shaped electrode 14b includes a plurality of the electrode fingers 12b and a bus bar 13b. The +X ends of the electrode fingers 12a extending in the X direction are coupled to the bus bar 13a extending in the Y direction, and the −X ends of the electrode fingers 12b extending in the X direction are coupled to the bus bar 13b extending in the X direction.

When viewed from the Y direction, the region where the electrode fingers 12a and 12b overlap is a fixed “overlap region” 26 where a surface acoustic wave propagates. In the overlap region 26, the electrode fingers 12a and 12b are alternately provided. The surface acoustic wave excited by the IDT 16 is reflected by the reflectors 17 and confined in the overlap region 26. The bus bars 13a and 13b of the IDT 16 are electrically connected to pads 15a and 15b, respectively.

The pads 15a and 15b are electrically connected to the terminals 19 provided on the upper surface of the substrate 11 through via wirings 18 (also referred to as through-hole electrodes) penetrating through the substrate 11. Thus, the terminals 19 are electrically connected to the IDT 16 of the surface acoustic wave resonator 25. An insulating film 20 is provided on the substrate 11 so as to cover the IDT 16 and the reflectors 17. The metal film 21 and the sensitive membrane 24 are provided in the overlap region 26 on the insulating film 20. A protection film 22 is provided so as to surround the metal film 21 and the sensitive membrane 24.

The substrate 11 is, for example, a piezoelectric substrate such as a lithium tantalate (LiTaO₃) substrate, a lithium niobate (LiNbO₃) substrate, or a quartz substrate. In some embodiments, the substrate 11 is, for example, a monocrystalline rotated Y-cut X-propagation lithium tantalate substrate or a monocrystalline rotated Y-cut X-propagation lithium niobate substrate. When the IDT 16 excites shear horizontal (SH) waves, the substrate 11 is a 32° to 50° rotated Y-cut lithium tantalate substrate. The substrate 11 may be a composite substrate in which a piezoelectric substrate is provided on an insulating substrate such as a sapphire substrate.

The IDT 16 and the reflectors 17 contain at least one of the following metals: for example, aluminum, copper and molybdenum, as a main component. The via wiring 18, the terminal 19, and the metal film 21 contain at least one of the following metals: for example, gold, copper, and aluminum as a main component. The insulating film 20 is a film for suppressing an electrical short-circuiting between the metal film 21 and the surface acoustic wave resonator 25, and is an inorganic insulating film such as a silicon oxide film or a silicon nitride film. The protection film 22 is a film for suppressing deterioration of the insulating film 20 due to contact of the liquid 55 with the insulating film 20. The protection film 22 is a resin film such as a permanent resist. The metal film 21 is provided to overlap the overlap region 26 in a plan view and be larger than the overlap region 26 in a plan view, and is a film for suppressing the influence of electrical perturbation. The metal film 21 contains, for example, gold as a main component.

The sensitive membrane 24 is, for example, an aggregate including an antibody connected to a connection portion such as a linker provided in the metal film 21. The antibody binds to a specific antigen in the liquid (for example, a protein to which the antibody binds in a virus, a bacterium, or the like, or another protein itself). The sensitive membrane 24 is an example, and may be any membrane capable of detecting an antigen. The liquid 55, which is a sample liquid, includes a body fluid such as saliva or blood.

When the substance or the like in the liquid 55 binds to the sensitive membrane 24, the sensitive membrane 24 becomes heavy. This increases the weight added to the IDT 16, and lowers the resonance frequency of the surface acoustic wave resonator 25. By detecting a change in the resonance frequency of the surface acoustic wave resonator 25, information on the substance in the liquid can be detected.

FIG. 8 is a cross-sectional view taken along line A-A in FIG. 4 to FIG. 5B. In FIG. 8, the housing body 60 and the lid member 62, which are not illustrated in FIG. 4 to FIG. 5B, are illustrated. The electrode fingers 12a and 12b in FIG. 6 are illustrated as electrode fingers 12. The same applies to the following drawings. A metal layer 43 is provided on the lower surface of the substrate 41. The metal layer 43 is bonded to a metal layer provided on the bottom surface of the housing chamber 61 of the housing body 60 using, for example, solder. The substrate 41 may be screwed to the housing body 60. A metal layer 33 is provided on the upper surface of the substrate 31. The elastic bodies 64 are provided between the metal layer 33 and the lid member 62. The elastic body 64 is, for example, a spring, and presses the sensor substrate 30 downward. When the housing body 60, the lid member 62, and the elastic body 64 are made of metal and the housing body 60 is supplied with a ground potential, the metal layers 33 and 43 are supplied with the ground potential. Some of the electrodes (including the electrode 32) provided on the lower surface of the substrate 31 may be electrically connected to the metal layer 33 provided on the upper surface of the substrate 31 through via wirings penetrating through the substrate 31. Some of the electrodes (including the electrodes 42 and 42a) provided on the upper surface of the substrate 41 may be electrically connected to the metal layer 43 provided on the lower surface of the substrate 41 through via wirings penetrating through the substrate 41.

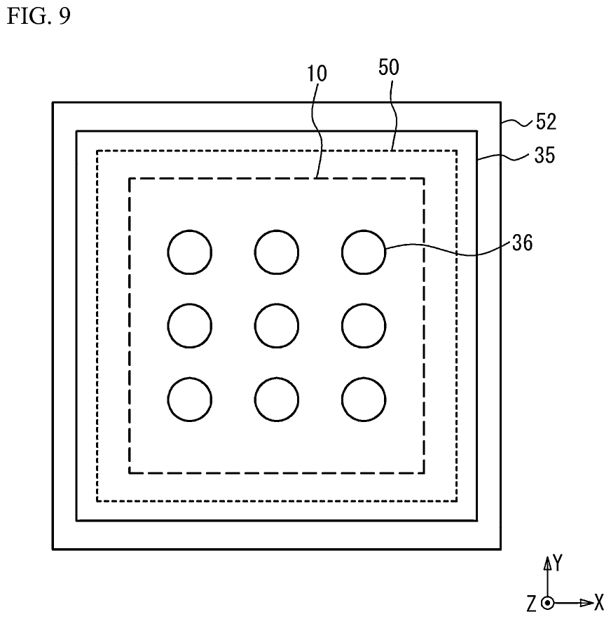

The terminals 19 provided on the upper surface of the sensor chip 10 are bonded to the electrodes 32 by solder or metal paste (not illustrated). Thus, the electrodes 32 are electrically connected to the IDT 16 through the terminals 19, the via wirings 18 (through-hole electrodes), and the pads 15a of the surface acoustic wave resonator 25. When the pressing member 35 presses the storage member 50, the liquid 55 in the storage member 50 is fed and introduced into the pressing member 35, and the sensitive membrane 24 is immersed in the liquid 55. FIG. 9 is a plan view of the tray, the storage member, and the sensor chip in the second embodiment. In FIG. 9, the sensor chip 10 is indicated by a dotted line, and the storage member 50 is indicated by a fine dotted line.

As illustrated in FIG. 9, the storage member 50 is provided on the bottom surface of the recess portion 53 (see FIG. 8) provided in the tray 52. The pressing member 35 also serves as a cover for the sensor chip 10 and is provided to cover the sensor chip 10. A plurality of openings 36 are provided so as to be scattered over substantially the entire region of a portion (lower plate 38a), which comes in contact with the storage member 50, of the pressing member 35. In FIG. 9, the openings 36 are provided in a 3×3 array. The number of the openings 36 can be set as appropriate. The planar shape of the opening 36 is, for example, circular.

The housing body 60 and the lid member 62 are made of a metal mainly composed of stainless steel or aluminum or an insulator such as a resin. The substrates 31 and 41 are made of an insulator such as resin or ceramics, and are, for example, printed circuit boards. The electrodes 32 and 42 and the metal layers 33 and 43 contain, for example, copper, gold, or aluminum as a main component. When the substrates 31 and 41 are printed circuit boards, the electrodes 32 and 42 and the metal layers 33 and 43 are formed of copper foil as a base, and the surface of the copper foil is plated with gold.

The pressing member 35 is a metal plate made of, for example, copper or aluminum. The pressing member 35 may be an insulating plate made of resin or the like. The pressing member 35 of FIG. 8 may have flexibility so as to be slightly deformed or crushed by pressure. In this case, when the pressing member 35 presses the storage member 50, the pressing member 35 is deformed. This can improve the degree of hermeticity of the space defined by the storage member 50, the pressing member 35, and the sensor chip 10. The sensitive membrane 24 becomes closer to the storage member 50. This makes it possible to more efficiently supply the liquid to the sensitive membrane 24, like a water gun effect. The thickness of the metal plate of the pressing member 35 is, for example, 0.05 mm to 0.5 mm, and the diameter of the opening 36 is, for example, 0.05 mm to 0.5 mm. The distance between the pressing member 35 and the sensitive membrane 24 is, for example, 0.05 mm to 0.5 mm. These dimensions can be set as appropriate.

The storage member 50 is, for example, sheet-like and contains fibers or resin. The fibrous body containing fibers is, for example, paper or nonwoven fabric, such as filter paper, absorbent cotton, or cloth. The resin-containing sheet is, for example, an open-cell sponge or gel. The storage member 50 is a member that has flexibility and can store liquid. When the storage member 50 is pressed, the liquid 55 is pushed out from the storage member 50.

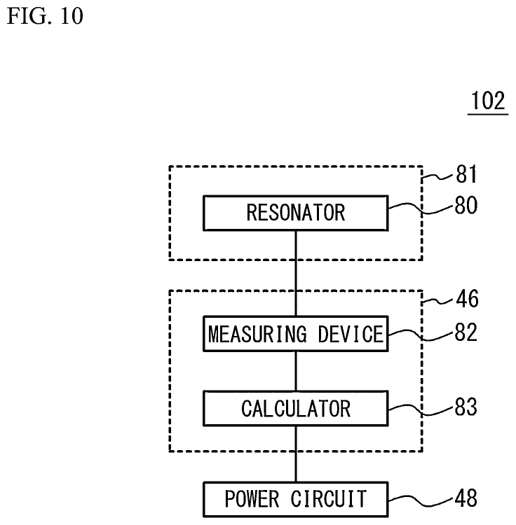

FIG. 10 is a block diagram of a detection device in the second embodiment. As illustrated in FIG. 10, the detection device 102 includes an oscillation circuit 81, the detection circuit 46, and the power circuit 48. The oscillation circuit 81 includes a resonator 80. The resonator 80 is the surface acoustic wave resonator 25. The oscillation circuit 81 outputs an oscillation signal having an oscillation frequency corresponding to the resonance frequency of the resonator 80. The detection circuit 46 includes a measuring device 82 and a calculator 83. The measuring device 82 measures the frequency of the oscillation signal output from the oscillation circuit 81. The measuring device 82 may be, for example, a network analyzer. The calculator 83 detects information on the substance or the like in the liquid based on the amount of change in the frequency of the oscillation signal measured by the measuring device 82. The power circuit 48 supplies power to the detection circuit 46.

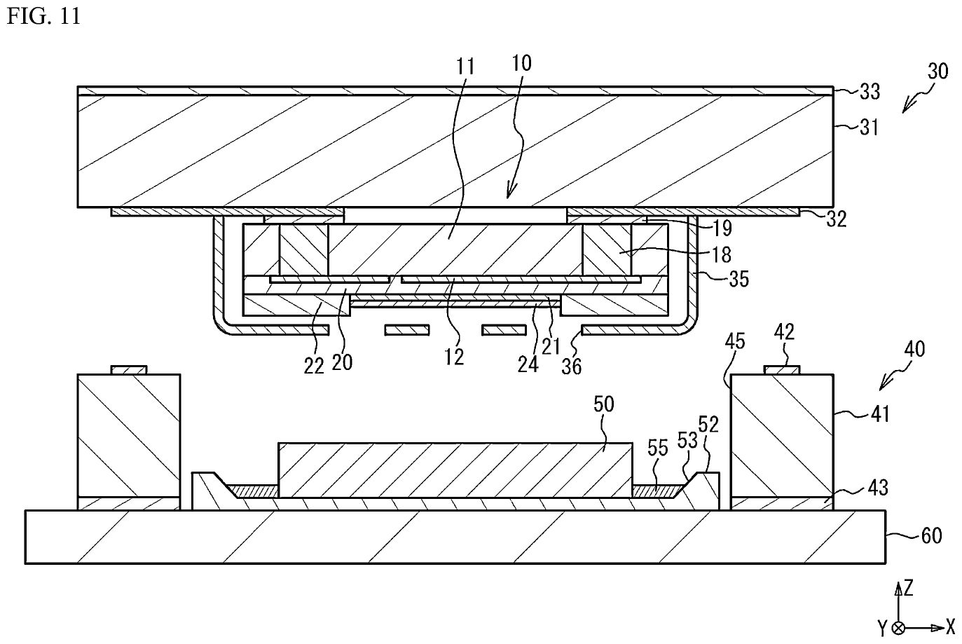

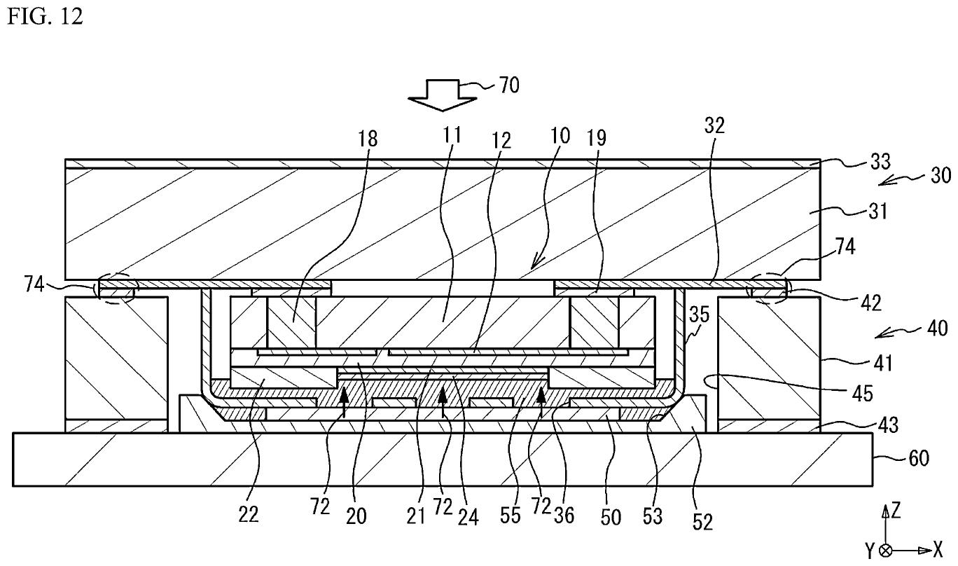

Next, a method of supplying a liquid to the sensitive membrane 24 in the second embodiment will be described with reference to FIG. 11 and FIG. 12.

In a state where the lid member 62 is removed from the housing body 60, as illustrated in FIG. 11, a tray provided with the storage member 50 impregnated with the liquid 55, which is a sample liquid, is placed on the bottom surface of the recess 45 of the support substrate 40. Then, the sensor substrate 30 is placed on the support substrate 40 so that the pressing member 35 is placed above the storage member 50.

As illustrated in FIG. 12, the sensor substrate 30 is placed on the support substrate 40, and the lid member 62 is attached to the housing body 60 (see FIG. 8). The elastic force of the spring of the elastic body 64 generates a downward external force indicated by the arrow 70, and the sensor substrate 30 is pressed toward the support substrate 40. When the storage member 50 is pressed by the pressing member 35, the pressed portion of the storage member 50 contracts and the volume of the storage member 50 becomes for example ½ or less of its original volume. This causes the liquid 55 to be discharged from the storage member 50. The liquid 55 is introduced between the pressing member 35 and the sensitive membrane 24 through the openings 36 of the pressing member 35 as indicated by the upward arrows 72. As a result, the sensitive membrane 24 comes into contact with the liquid 55.

As can be seen from FIG. 12, the recess portion 53 of the tray 52 has inclined side surfaces that surround the periphery of the bottom surface. When the inclined side surface and the periphery of the bottom surface of the pressing member 35 come into contact with each other, the openings 36 of the pressing member 35 serve as a relief path for the liquid 55. Therefore, the liquid 55 is fed upward without spilling from the tray 52, and is absorbed by the sensitive membrane 24.

At the same time as pressing, the electrodes 32 and 42 come into contact with each other in the regions 74. Thus, the detection circuit 46 is electrically connected to the surface acoustic wave resonator 25 through the electrode 42, the electrode 32, the terminal 19, and the via wiring 18. Thus, the detection circuit 46 can detect a substance or the like in the liquid 55 based on a change in the resonance frequency of the surface acoustic wave resonator 25.

Then, the lid member 62 is removed from the housing body 60, and thus the sensor substrate 30 and the liquid 55, which is a sample liquid, can be easily replaced. In the second embodiment, the liquid 55 can be supplied to the sensitive membrane 24 without the sensitive membrane 24 directly contacting the storage member 50.

The pressing member 35 is a cover that covers the sensor chip 10 and is fixed to the sensor substrate 30 around the sensor chip 10. Thus, the pressing member 35 can be used as a cover for protecting the sensor chip 10.

The sensor chip 10 includes a sensor (surface acoustic wave resonator 25) having the sensitive membrane 24. The electrode 32 (first electrode) is electrically connected to the surface acoustic wave resonator 25. The detection circuit 46 for detecting a substance in the liquid 55 from the output of the surface acoustic wave resonator 25 is provided on the support substrate 40, which serves as a mother board. The electrode 42 is electrically connected to the detection circuit 46. Thus, when the sensor substrate 30 is pressed toward the support substrate 40, and the electrodes 32 and 42 are brought into contact with each other, the detection circuit 46 and the surface acoustic wave resonator 25 can be electrically connected to each other.

The recess 45 (a recess portion or an opening) in which the sensor chip 10 is accommodated is provided on the upper surface of the support substrate 40, and the storage member 50 is provided on the bottom surface of the recess 45. Thus, when the sensor chip 10 and the pressing member 35 are inserted into the recess 45, and the pressing member 35 presses the storage member 50, the electrode 32 on the lower surface of the sensor substrate 30 comes into contact with the electrode 42 on the upper surface of the support substrate 40. If the support substrate 40 is thicker than the sensor chip 10, a leveling member may be disposed under the tray 52. The recess 45 may not necessarily penetrate through the support substrate 40 in the Z direction.

The elastic body 64 presses the sensor substrate 30 downward. This allows the pressing member 35 to press the storage member 50, and the electrode 32 to come into contact with the electrode 42.

### First Variation of Second Embodiment: Omission of Pressing Member

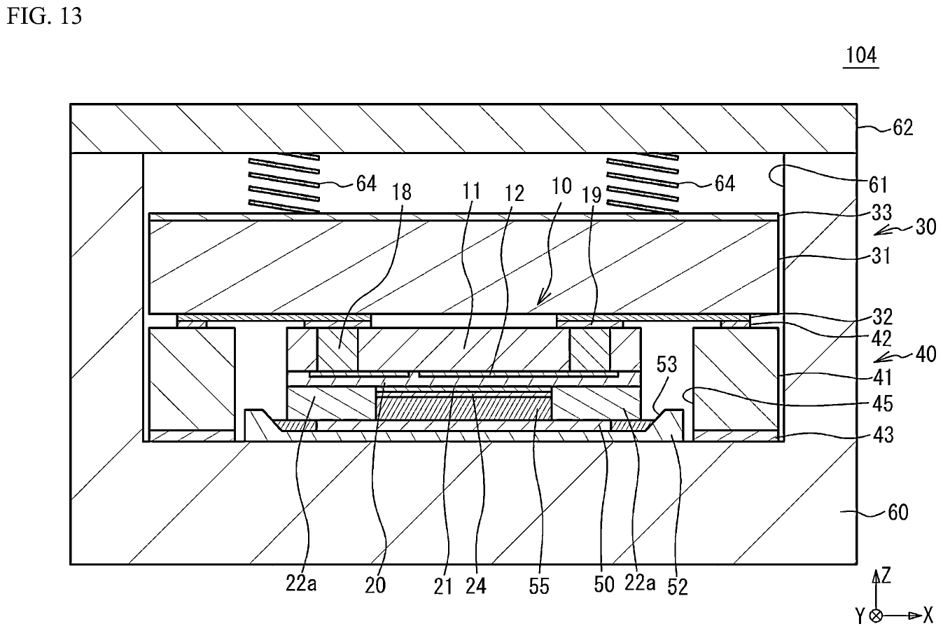

FIG. 13 is a cross-sectional view of a detection device in accordance with a first variation of the second embodiment. As illustrated in FIG. 13, a detection device 104 does not include the pressing member 35 that functions as a cover. A protection film 22a is thicker than the protection film 22 of FIG. 7 of the second embodiment. The protection film 22a has a thickness of, for example, 10 μm to 200 μm. The thickness of the protection film 22a can be set as appropriate. The protection film 22a is provided so as to surround the sensitive membrane 24, similarly to the protection film 22 of FIG. 6. The liquid is introduced into a space surrounded by the protection film 22a, the sensitive membrane 24, and the storage member 50 when the protection film 22a presses the storage member 50. Thus, the sensitive membrane 24 is exposed to the liquid 55. Other configurations are the same as those of the second embodiment, and the description thereof is omitted.

In the first variation of the second embodiment, the protection film 22a is provided on the lower surface of the sensor chip 10 so as to surround the sensitive membrane 24. Thus, the protection film 22a can be used as the pressing member without providing the pressing member 35. Therefore, the detection device 104 can be miniaturized and the cost can be reduced.

### Second Variation of Second Embodiment: Pressing Member is Formed on Sensor Chip

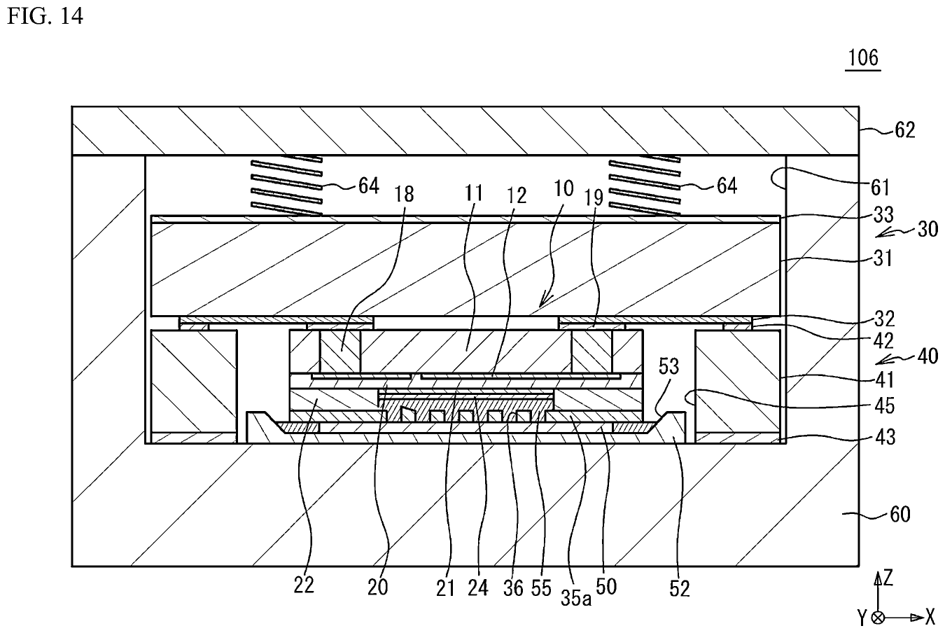

FIG. 14 is a cross-sectional view of a detection device 106 in accordance with a second variation of the second embodiment. As illustrated in FIG. 14, in the detection device 106 of the second variation of the second embodiment, the pressing member 35 fixed to the sensor substrate 30 is not provided. Instead of the pressing member 35, a pressing member 35a is provided on the lower surface of the protection film 22 on the sensor chip 10 side. The pressing member 35a is bonded to the protection film 22. When the pressing member 35a presses the storage member 50, the liquid 55 is introduced into the space surrounded by the pressing member 35a, the protection film 22, and the sensitive membrane 24 through the openings 36. Thus, the sensitive membrane 24 is exposed to the liquid 55.

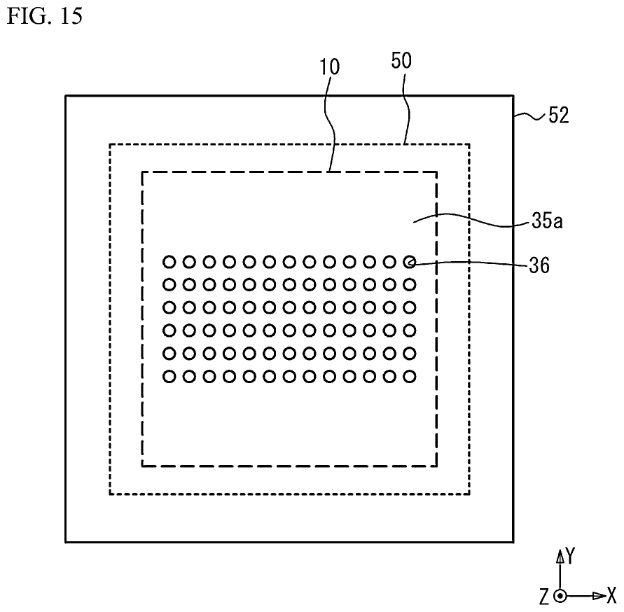

FIG. 15 is a plan view of the tray, the storage member, and the sensor chip in the second variation of the second embodiment. The storage member 50 is indicated by dotted lines.

The pressing member 35a is provided on the lower surface of the sensor chip 10. The pressing member 35a has the openings 36 overlapping the sensitive membrane 24. The thickness of the metal plate of the pressing member 35a is, for example, 0.05 mm to 0.5 mm, and the diameter of the opening 36 is, for example, 0.05 mm to 0.5 mm. The distance between the pressing member 35a and the sensitive membrane 24 is, for example, 0.05 mm to 0.5 mm. These dimensions can be set as appropriate. The pressing member 35a is, for example, an insulating plate such as glass, a metallic plate, or a rigid resin plate. To suppress electrical short-circuiting between the pressing member 35a and the metal film 21 or between the pressing member 35a and the surface acoustic wave resonator 25 through the liquid 55, the pressing member 35a is preferably an insulator. The pressing member 35a and the protection film 22 are bonded to each other by, for example, an adhesive or an adhesive sheet. Other configurations are the same as those of the second embodiment, and the description thereof is omitted.

In the third variation of the second embodiment, the pressing member 35a is fixed to the surface of the sensor chip 10 corresponding to the periphery of the sensitive membrane 24. As described above, the pressing member 35a may be fixed to the sensor chip 10.

### Third Embodiment

[Disposition of Recesses in which Liquid is Stored in Pressed Portion of Storage Member]

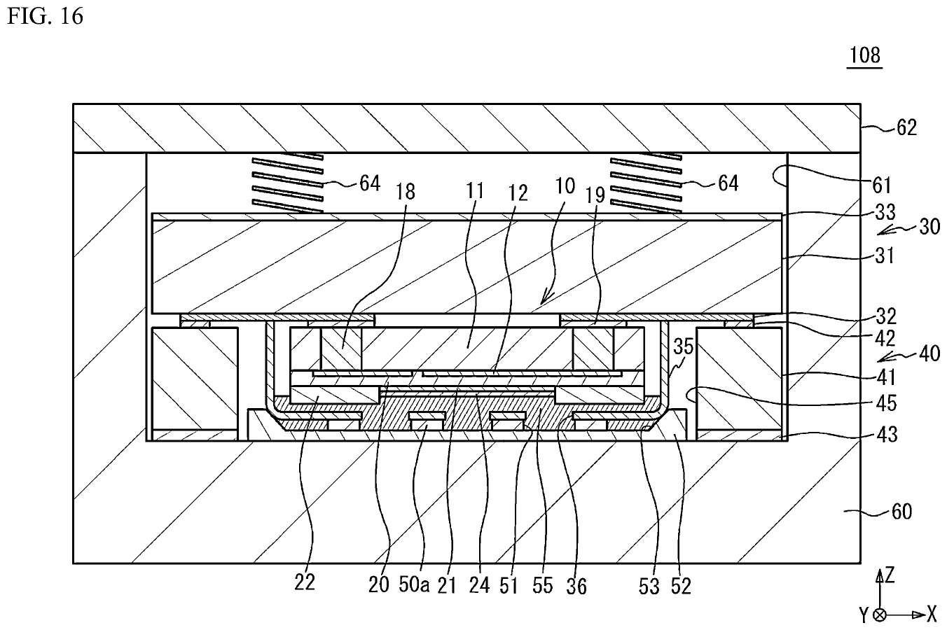

FIG. 16 is a cross-sectional view of a detection device 108 in accordance with a third embodiment. In the detection device 108, recesses 51 (for example, openings that vertically penetrate through a storage member 50a) are provided on the upper surface of the storage member 50a, and the liquid 55 is stored in the recess 51. The storage member 50a absorbs little liquid 55, but is flexible. The storage member 50a is made of, for example, a fluorine resin such as polytetrafluoroethylene. The storage member 50a may be made of any flexible material, for example, resin.

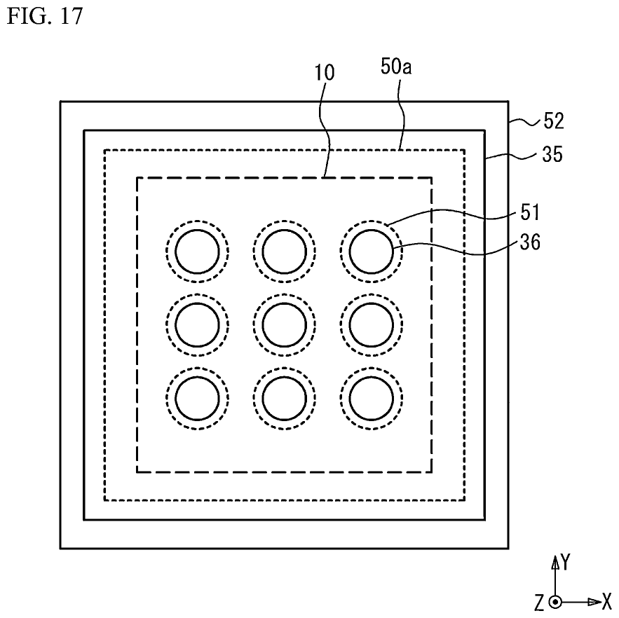

FIG. 17 is a plan view of the pressing member, the tray, the storage member, and the sensor chip in the third embodiment. The sensor chip 10 is indicated by a dotted line, and the storage member 50a is indicated by a fine dotted line. The recesses 51 are provided on the upper surface of the storage member 50a. At least a part of the recess 51 is provided so as to overlap at least a part of the opening 36 of the pressing member 35. Other configurations are the same as those of the second embodiment, and the description thereof is omitted.

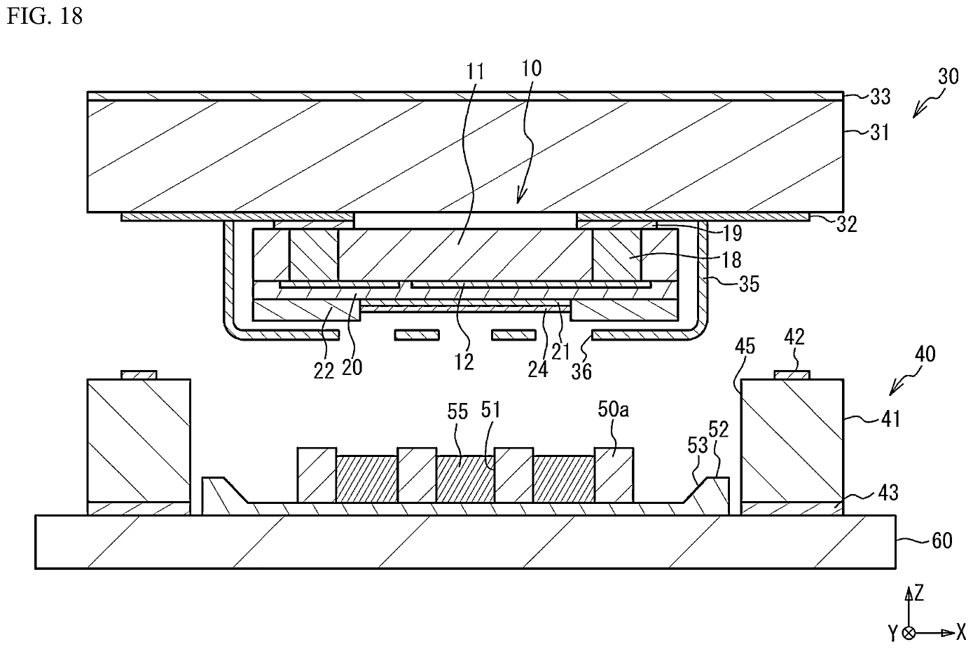

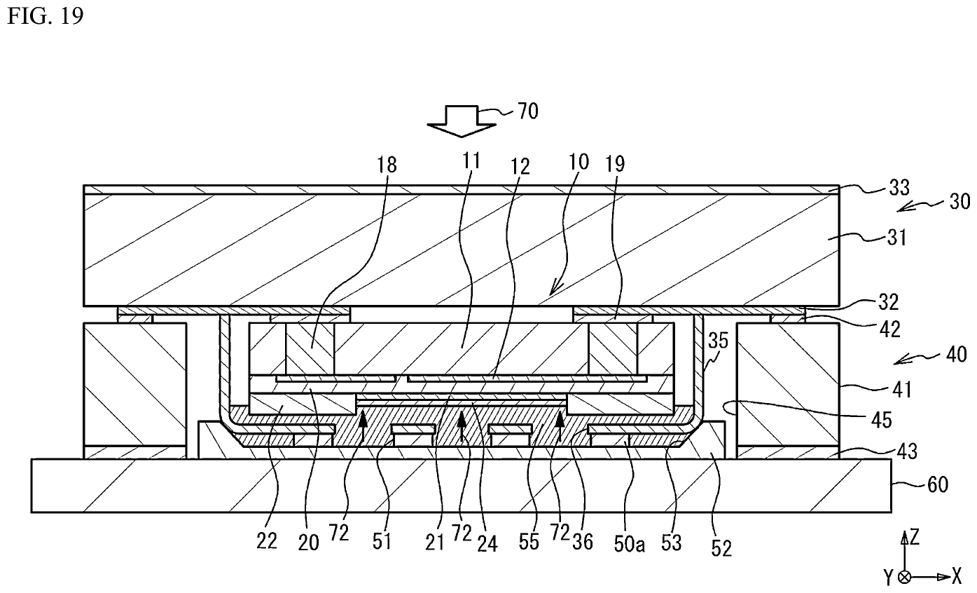

A method of supplying a liquid to the sensitive membrane 24 in the third embodiment will be described with reference to FIG. 18 and FIG. 19.

As illustrated in FIG. 18, in a state where the pressing member 35 is not in contact with the storage member 50a, the liquid 55 is stored in the recess 51 of the storage member 50a.

As illustrated in FIG. 19, when the lower surface of the pressing member 35 presses the storage member 50a downward as indicated by the arrow 70, the liquid 55 in the recesses 51 is introduced into the pressing member 35 through the openings 36 with a great force in the upward direction as indicated by the arrows 72. The principle is as if a water gun were injecting liquid, and since the diameters of the individual recesses 51 of the storage member 50a are small, a slight lateral force acts on the liquid 55 when the storage member 50a is pressed, and therefore, water can be introduced into the pressing member 35 with great force. Thus, the sensitive membrane 24 is exposed to the liquid 55. With this configuration, the liquid feeding speed can be improved.

In the third embodiment, the storage member 50a has the recesses 51 in which the liquid 55 is stored. The pressing member 35 has the openings 36 overlapping the recesses 51, respectively, in a plan view. When the pressing member 35 presses the storage member 50a, the liquid 55 is supplied to the sensitive membrane 24 through the openings 36. Therefore, even when the storage member 50a does not absorb the liquid 55, the liquid 55 can be supplied to the sensitive membrane 24. The pressing member may be the pressing member 35a fixed to the protection film 22 as in the second variation of the second embodiment.

In the second and third embodiments, the surface acoustic wave (SAW) resonator 25 is described as an example of the sensor. However, the sensor may be a bulk acoustic wave (BAW) resonator such as a film bulk acoustic resonator (FBAR) or a solidly mounted resonator (SMR). The sensor may be a delay line sensor having a delay line between IDTs. The sensor may be a quartz crystal microbalance (QCM). Sensors other than those described above can be used as the sensor. Although the example in which one sensor is provided on the sensor substrate 30 has been described, a plurality of sensors may be provided on the sensor substrate 30.

Although the embodiment of the present disclosure has been described in detail above, the present disclosure is not limited to the specific embodiment, and various modifications and changes can be made within the scope of the gist of the present disclosure described in the claims.

What is claimed is:

1. A detection device comprising:
a storage member in which liquid is stored;
a sensor chip that is provided over the storage member and has a sensitive membrane on a lower surface thereof; and
a pressing member that is provided below the sensitive membrane, and presses the storage member to supply the liquid to the sensitive membrane when the sensor chip is pressed downward.

2. The detection device according to claim 1, wherein the storage member includes a sheet containing a fiber or a resin.

3. The detection device according to claim 1, wherein the storage member absorbs the liquid and discharges the liquid by being pressed by the pressing member.

4. The detection device according to claim 2,
wherein the pressing member has a plurality of openings in a portion that is provided below the sensitive membrane so as to be away from the sensitive membrane and is to come into contact with the storage member, and
wherein the liquid is supplied to the sensitive membrane through the plurality of openings by the pressing member pressing the storage member.

5. The detection device according to claim 2, wherein the pressing member is provided on the lower surface of the sensor chip so as to surround the sensitive membrane.

6. The detection device according to claim 1, further comprising:
an elastic body that presses the sensor chip downward.

7. The detection device according to claim 1, further comprising:
a tray that has a recess portion formed on an upper surface thereof,
wherein the storage member is sheet-like, and is located in the recess portion.

8. The detection device according to claim 1,
wherein the storage member has a recess portion that stores the liquid,
wherein the pressing member has an opening that is provided below the sensitive membrane so as to be away from the sensitive membrane and overlaps the recess portion in a plan view, and
wherein the liquid is supplied to the sensitive membrane through the opening by the pressing member pressing the storage member.

9. The detection device according to claim 1, further comprising:
a sensor substrate that has a lower surface on which the sensor chip is mounted and includes a first electrode electrically connected to the sensor chip on the lower surface; and
a support substrate that is provided below the sensor substrate and has a second electrode provided on an upper surface thereof,
wherein the sensor chip presses the storage member, and the first electrode comes into contact with the second electrode by the sensor substrate being pressed downward.

10. The detection device according to claim 9,
wherein the sensor chip is provided with a sensor having the sensitive membrane,
wherein the first electrode is electrically connected to the sensor,
wherein a detection circuit that detects a substance in the liquid from an output of the sensor is provided on the support substrate, and
wherein the second electrode is electrically connected to the detection circuit.

11. The detection device according to claim 9,
wherein a recess into which the sensor chip is accommodated is provided on an upper surface of the support substrate, and
wherein the storage member is provided on a bottom surface of the recess.

12. The detection device according to claim 9, further comprising an elastic body that presses the sensor substrate downward.

13. The detection device according to claim 9, wherein the pressing member is a cover that covers the sensor chip and is fixed to the sensor substrate around the sensor chip.

14. A method of driving a detection device, the method comprising:
preparing:
a sensor chip having a sensitive membrane on a lower surface thereof,
a sensor substrate having a lower surface on which the sensor chip is provided, a first electrode electrically connected to the sensor chip being provided around the sensor chip,
a support substrate that has a recess or an opening portion in which the sensor chip is accommodated, and has a second electrode on an upper surface of the support substrate at a position opposite the first electrode of the sensor substrate; and
inserting the sensor chip into the recess or the opening portion of the support substrate, and electrically connecting the first electrode and the second electrode by a force applied to the sensor substrate toward the support substrate.

15. The method according to claim 14, wherein the preparing includes preparing an elastic body that presses the sensor substrate toward the support substrate.

16. The method according to claim 14,
wherein the preparing includes preparing a tray that has a recess portion formed on an upper surface thereof, and a storage member in which liquid is stored, and
wherein the storage member is sheet-like, and is located in the recess portion.
